(19) United States
(12) Patent Application Publication
(10) Pub. No.: US 2008/0042928 A1
(43) Pub. Date: Feb. 21, 2008

(54) Electrophoretic Display Panel

(75) Inventors: Lucas Josef Maria Schlangen, Eindhoven (NL); Mark Thomas Johnson, Eindhoven (NL); Patrick John Baesjou, Eindhoven (NL); Peter Alexander Duine, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/573,279

(22) PCT Filed: Jul. 25, 2005
(86) PCT No.: PCT/IB05/52489

§ 371 Date: Feb. 6, 2007

(30) Foreign Application Priority Data
Aug. 10, 2004 (EP) 04103839.9

(51) Int. Cl. G09G 3/34; G02F 1/167

(52) U.S. Cl. 345/55; 345/214

(57) ABSTRACT

For the electrophoretic display panel (1) to be able to have a pixel (2) which is able to have a relative large number of different attainable optical states for displaying a picture, even if the pixel (2) has three electrodes, the electrophoretic display panel (1) has a pixel (2) and drive means (100); the pixel (2) has an electrophoretic medium (5) having first and second charged particles (6,7), the first and the second particles (6,7) having opposite polarity and dissimilar optical properties and being able to occupy positions in the pixel (2), a first, a second and a reset electrode (11,12,13) for receiving potentials, and an optical state depending on the positions of the particles (6,7) in the pixel (2); the drive means (100) are arranged for controlling a sequence of the potentials received by the electrodes (11,12,13) for enabling the first and the second particles (6,7) to occupy their positions for displaying the picture, the sequence comprising first particles positioning potentials for enabling the first particles (6) to occupy a position for displaying the picture, subsequently second particles reset potentials for enabling the second particles (7) to occupy a position near the reset electrode (13) and for preventing the first particles (6) from substantially changing their contribution to the optical state of the pixel (2), subsequently second particles positioning potentials for enabling the second particles (7) to occupy a position for displaying the picture and for preventing the first particles (6) from substantially changing their contribution to the optical state of the pixel (2).

The invention relates to an electrophoretic display panel for displaying a picture.

The invention also relates to a display device comprising such a display panel.

The invention also relates to a method of driving such a display panel.

The invention also relates to drive means for driving such a display panel.

An electrophoretic display panel for displaying a picture is disclosed in WO99/53373.

Electrophoretic display panels in general are based on the motion of charged, usually colored particles under the influence of an electric field between electrodes. With these display panels, dark or colored characters can be imaged on a light or colored background, and vice versa. Electrophoretic display panels are therefore notably used in display devices taking over the function of paper, referred to as “paper white” applications, e.g. electronic newspapers and electronic diaries.

The disclosed electrophoretic display panel is a color display panel. The pixel has a top electrode at the side facing the viewer, and two bottom electrodes at the side facing away from the viewer, negatively charged white particles and positively charged red particles in a clear, dispersing fluid between the electrodes. A gap exists between the two bottom electrodes. The clear top electrode allows light to pass into the pixel and to strike the white particles, the red particles, or a colored substrate at the side facing away from the viewer.

If the top electrode is set at a positive potential relative to the bottom electrodes, the white particles move to the top and the red particles to the bottom and thus white is displayed. By reversing the polarity of the electrodes, red is displayed. In both cases the particles obscure the substrate. If one of the bottom electrodes is at a negative potential relative to the other bottom electrode, while the top electrode is at a potential between the potentials of the bottom electrodes, the red particles move toward the bottom electrode having the lowest potential and the white particles move toward the bottom electrode having the highest potential and both the red and white particles move away from the gap. This reveals the substrate, permitting a third color, e.g. cyan to be imaged. This system, called “dual particle curtain mode,” can image three different colors and the pixel has three different attainable optical states. However, the pixel has a relative small number of different attainable optical states.

It is an object of the invention to provide an electrophoretic display panel which has a pixel which is able to have a relative large number of different attainable optical states, even if the pixel has three electrodes.

To achieve this object, the invention provides an electrophoretic display panel for displaying a picture comprising
a pixel having
   an electrophoretic medium comprising first and second charged particles, the first and the second particles having opposite polarity and dissimilar optical properties and being able to occupy positions in the pixel,
   a first, a second and a reset electrode for receiving potentials,
   an optical state depending on the positions of the particles in the pixel, and
drive means for controlling a sequence of the potentials received by the electrodes for enabling the first and the second particles to occupy their positions for displaying the picture, the sequence comprising
   first particles positioning potentials for enabling the first particles to occupy a position for displaying the picture, subsequently
   second particles reset potentials for enabling the second particles to occupy a position near the reset electrode and for preventing the first particles from substantially changing their contribution to the optical state of the pixel, subsequently
   second particles positioning potentials for enabling the second particles to occupy a position for displaying the picture and for preventing the first particles from substantially changing their contribution to the optical state of the pixel.

As a result of the sequence of potentials it is achieved that the first and the second particles can independently be moved to their respective position for displaying the picture. Therefore, optical states determined by mixtures of the first and the second particles are attainable, the mixtures being adjustable, resulting in a relative large number of different attainable optical states. Furthermore, due to the second particles reset potentials the history dependency of the position of the second particles is reduced, thereby improving the accuracy of the picture.

In an embodiment the first particles positioning potentials comprise first particles fill potentials for enabling the first particles to occupy a position near the first electrode based on the position for displaying the picture, and subsequently reversal potentials for enabling the first particles to occupy a position near the second electrode for displaying the picture. In a variation on the embodiment the reversal potentials further enable the second particles to occupy a position near the first electrode. This enhances the speed of the image update sequence. If, furthermore, the sequence comprises first particles reset potentials for enabling the first particles to occupy a position near the reset electrode prior to the first particles positioning potentials, the accuracy of the picture is further improved.

In another embodiment the pixel has a viewing surface for being viewed by a viewer, and the first, the second and the reset electrodes have substantially flat surfaces facing the particles, and the surfaces of the first and the second electrodes are substantially parallel to the viewing surface. Then the first and the second electrode can relatively simply be manufactured. In a variation on the embodiment the electrophoretic medium is present between the first and the second electrode, one of the first and the second electrode being at the viewer side and the other of the first and the second electrode being at the opposite side. This can improve the aperture of the pixel. If, furthermore, the surface of the reset electrode is substantially parallel to the viewing surface and the surfaces of the reset electrode and one of the first and the second electrodes are present in a substantially flat plane, the manufacturing process of the two electrodes in the substantially flat plane is further simplified. In a variation on the embodiment the surfaces of the reset electrode and the first electrode are present in the substantially flat plane and a perpendicular projection of the surface of the second electrode substantially covers the surfaces of the first electrode and the reset electrode. This improves the accuracy of the reversal operation.

In another embodiment the pixel comprises a reservoir portion substantially non-contributing to the optical state of the pixel and an optical active portion substantially contributing to the optical state of pixel. Then the particles in the reservoir are hidden from the viewer. In a variation on the embodiment the reservoir portion comprises the reset electrode. Then the contrast of the picture is improved. In a further variation on the embodiment the reservoir portion comprises a part of the second electrode. Then the accuracy of the picture is further improved.

In an embodiment the reset electrodes and second electrodes may be common electrodes for a plurality of pixels or even for the entire display. In this case, the group of pixels which is associated with the interconnected reset electrodes and the second electrodes, respectively, only require, per pixel, individual driving of the first electrode. Thus only a single drive transistor, usually a TFT (Thin Film Transistor), which is coupled to the first electrode, is required for each pixel.

In another embodiment
the pixel has
   a cell comprising the electrophoretic medium, the first and the second particles being able to occupy positions in the cell,
   a further cell stacked on the cell, the further cell comprising a further electrophoretic medium comprising third charged particles, the third particles having dissimilar optical properties with respect to the first and the second particles and being able to occupy positions in the further cell,
   further electrodes for receiving potentials,
   an optical state depending on the position of the third particles in the pixel, and
the drive means are able to control a sequence of the potentials received by the electrodes and the further electrodes for enabling the first, the second and the third particles to occupy their positions for displaying the picture. Then color combinations in the cell and the further cell of the pixel enable to pixel to have a relative large number of different attainable optical states, which can be advantageously used in a color display panel. If, furthermore, the drive means are able to control the sequence of the potentials received by the further electrodes for enabling the third particles to occupy their positions for displaying the picture, then the driving of the cell is independent from the driving of the further cell.

In another embodiment
the pixel has
   a cell comprising the electrophoretic medium, the first and the second particles being able to occupy positions in the cell,
   a further cell stacked on the cell, the further cell comprising a further electrophoretic medium comprising third and fourth charged particles, the third and the fourth particles having opposite polarity and dissimilar optical properties and dissimilar optical properties with respect to the first and the second particles and being able to occupy positions in the further cell,
   further electrodes for receiving potentials,
   an optical state depending on the position of the third and the fourth particles in the pixel, and
the drive means are able to control a sequence of the potentials received by the electrodes and the further electrodes for enabling the first, the second, the third and the fourth particles to occupy their positions for displaying the picture. Then color combinations in the cell and the further cell of the pixel enable the pixel to have an even larger number of different attainable optical states, which can be advantageously used in a color display panel.

If, furthermore, the drive means are able to control the sequence of the potentials received by the further electrodes for enabling the third and the fourth particles to occupy their positions for displaying the picture, then the driving of the cell is independent from the driving of the further cell.

In another embodiment, the display panel is an active matrix display panel.

Another aspect of the invention provides a display device as claimed in claim 17.

Yet another aspect of the invention provides a method of driving an electrophoretic display panel as claimed in claim 18.

Yet another aspect of the invention provides drive means for driving an electrophoretic display panel as claimed in claim 19.

The mere fact that certain measures are mentioned in different claims does not indicate that a combination of these measures cannot be used to advantage.

Electrophoretic systems can form the basis of a variety of applications where information may be displayed, for example in the form of information signs, public transport signs, advertising posters, pricing labels, billboards etc. In addition, they may be used where a changing non-information surface is required, such as wallpaper with a changing pattern or color, especially if the surface requires a paper like appearance.

These and other aspects of the display panel of the invention will be further elucidated and described with reference to the drawings, in which:

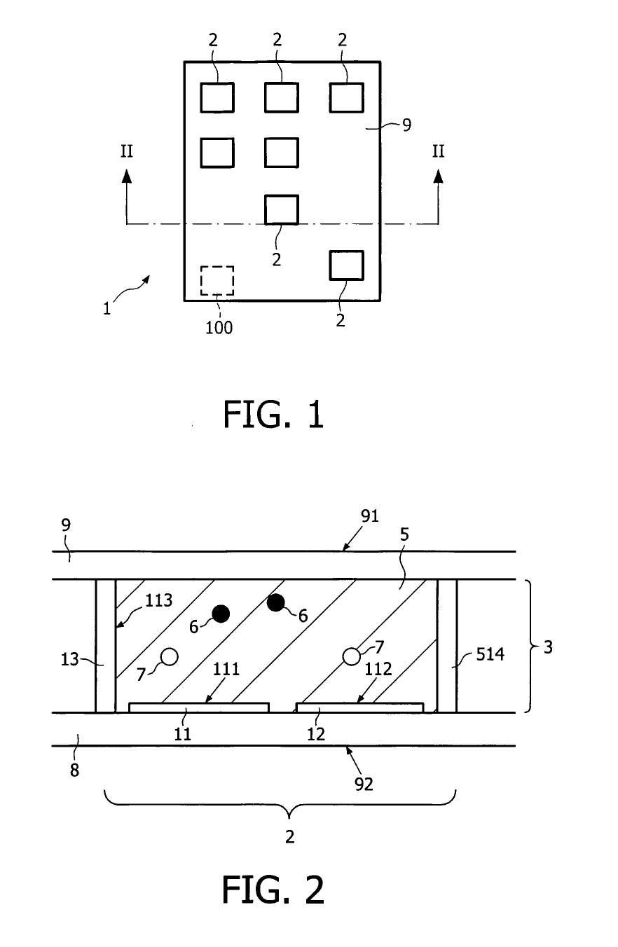

FIG. 1 shows diagrammatically a front view of an embodiment of the display panel;

FIG. 2 shows diagrammatically a cross-sectional view along II-II in FIG. 1;

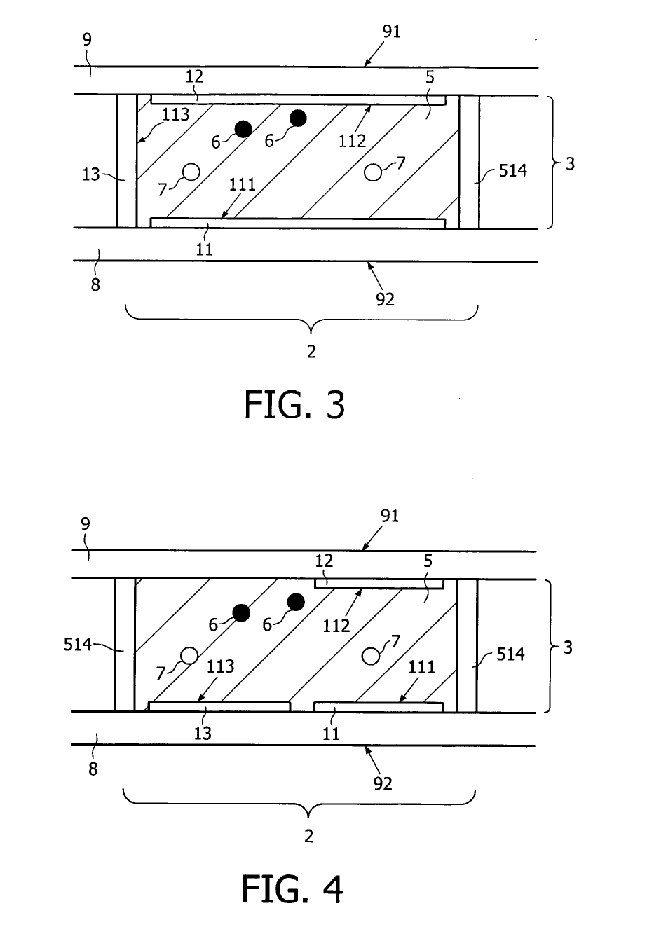

FIG. 3 shows diagrammatically a cross-sectional view along II-II in FIG. 1 of another embodiment of the display panel;

FIG. 4 shows diagrammatically a cross-sectional view along II-II in FIG. 1 of another embodiment of the display panel;

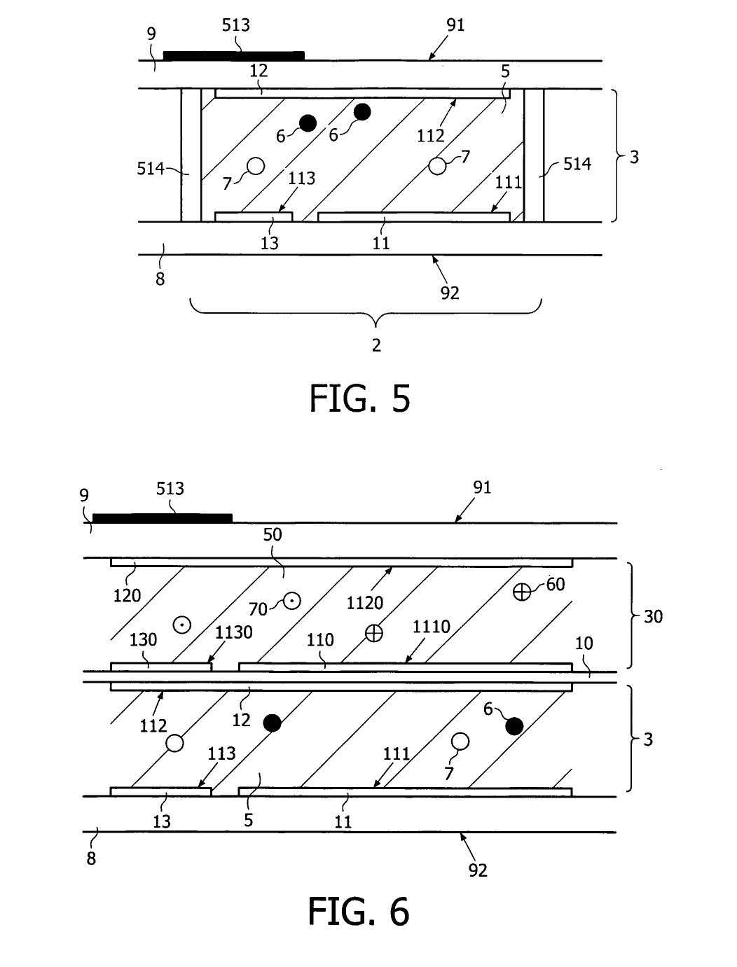

FIG. 5 shows diagrammatically a cross-sectional view along II-II in FIG. 1 of another embodiment of the display panel;

FIG. 6 shows diagrammatically a cross-sectional view along II-II in FIG. 1 of another embodiment of the display panel;

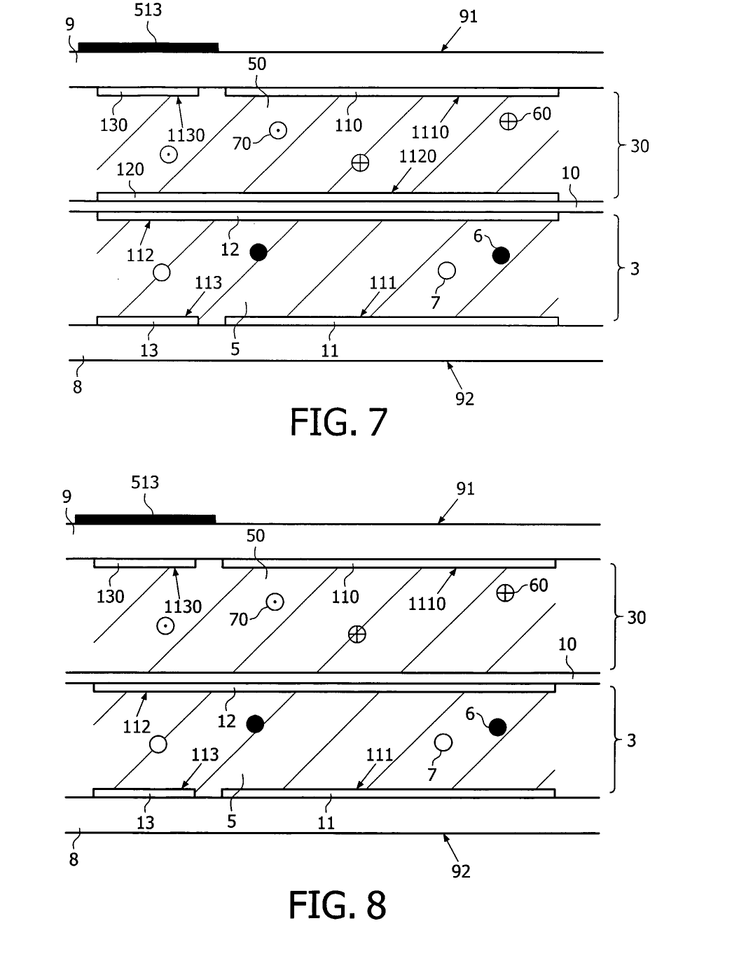

FIG. 7 shows diagrammatically a cross-sectional view along II-II in FIG. 1 of another embodiment of the display panel;

FIG. 8 shows diagrammatically a cross-sectional view along II-II in FIG. 1 of another embodiment of the display panel; and

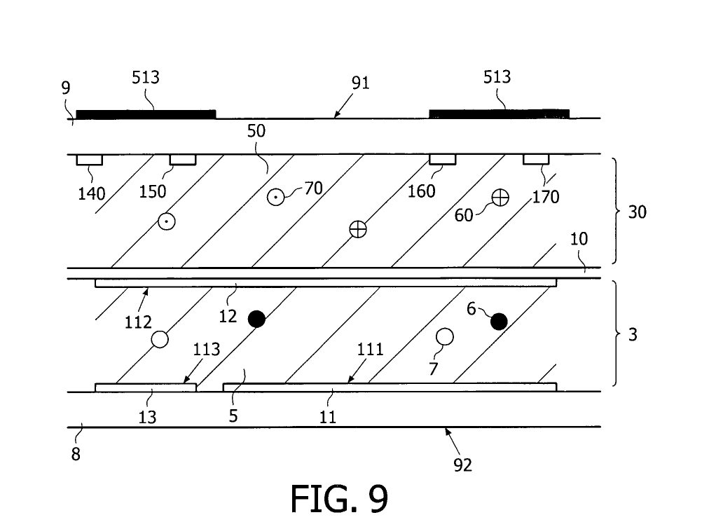

FIG. 9 shows diagrammatically a cross-sectional view along II-II in FIG. 1 of another embodiment of the display panel.

In all the Figures corresponding parts are referenced to by the same reference numerals.

FIGS. 1 and 2 show an example of the display panel 1 having a first substrate 8, a second transparent opposed substrate 9 and a plurality of pixels 2. Preferably, the pixels 2 are arranged along substantially straight lines in a two-dimensional structure. Other arrangements of the pixels 2 are alternatively possible, e.g. a honeycomb arrangement. In an active matrix embodiment, the pixels 2 may further comprise switching electronics, for example, thin film transistors (TFTs), diodes, MIM devices or the like.

The pixel 2 has a cell 3, having an electrophoretic medium 5. The electrophoretic medium 5, having first charged and second charged particles 6,7 in a transparent fluid, is present between the substrates 8,9. Electrophoretic media 5 are known per se from e.g. US 2002/0180688, this document being incorporated by reference herein. The first and the second particles 6,7 have opposite polarity and dissimilar optical properties and are able to occupy positions in the cell 3. The first charged particles 6 have a first optical property. The second charged particles 7 have a second optical property different from the first optical property. The first particles 6 may have any color, whereas the second particles 7 may have any color different from the color of the first particles 6. The first and second particles 6,7 may have subtractive primary colors, e.g. the first particles 6 being cyan and the second particles 7 being magenta. Other examples of the color of the first particles 6 are for instance red, green, blue, yellow, cyan, magenta, white or black. The particles may be large enough to scatter light, or small enough to substantially not scatter light. In the examples the latter is the case. The pixel 2 has a viewing surface 91 for being viewed by a viewer. Furthermore, the barrier 514 forming a pixel wall separates a pixel 2 from its environment. The optical state of the pixel 2 depends on the positions of the first and the second particles 6,7 in the cell 3.

The pixel 2 has three electrodes, which are able to receive potentials from the drive means 100. Each one of the three electrodes can be addressed as the first electrode 11, the second electrode 12 and the reset electrode 13. This depends on the potentials applied by the drive means 100. Furthermore, the drive means 100 are able to control a sequence of the potentials received by the electrodes 11,12,13 for enabling the first and the second particles 6,7 to occupy their positions for displaying the picture. The sequence comprises first particles positioning potentials for enabling the first particles 6 to occupy a position for displaying the picture, subsequently second particles reset potentials for enabling the second particles 7 to occupy a position near the reset electrode 13 and for preventing the first particles 6 from substantially changing their position, subsequently second particles positioning potentials for enabling the second particles 7 to occupy a position for displaying the picture and for preventing the first particles 6 from substantially changing their position.

In this case, each one of the electrodes 11,12,13 has a substantially flat surface 111,112,113 facing the particles 6,7. Furthermore, in this layout the electrodes 11,12,13 are arranged to enable the particles 6,7 to move in a plane parallel to the viewing surface 91.

In the embodiment of FIG. 2 the surfaces 111,112 substantially cover the surface of the first substrate 8 in the cell 3 and the reset electrode 13 is substantially not contributing to the optical state. The surfaces 111,112 each relate 50% to the optical state of the pixel 2.

Therefore, the positions of the particles 6,7 in the cell 3 and the surfaces 111,112 of the first and the second electrode 11,12 substantially determine the optical state of the pixel 2.

Consider the first particles 6 to be positively charged and to have a red color, the second particles 7 to be negatively charged and to have a green color and the surfaces 111,112 of the first and the second electrode 11,12 to be white. In this embodiment the display panel 1 is used in light reflective mode. In reflective mode, the optical state of the pixel 2 is determined by the portion of the visible spectrum incident on the pixel 2 at the viewing surface 91 of the second substrate 9 that survives the cumulative effect of traversing through the second substrate 9, the electrophoretic medium 5, subsequently interacting with surfaces 111,112 of the first and the second electrode 11,12 and subsequently traversing back through electrophoretic medium 5 and the second substrate 9.

To obtain an optical state being red, the red particles 6 are brought in their collected state near the surfaces 111,112 of the first and the second electrode 11,12, by appropriately changing the potentials received by the electrodes 11,12,13, e.g. the electrodes 11,12,13 receive first particles positioning potentials of −10 Volts, −10 Volts and 0 Volts, respectively. The movement of the second particles 7 has a component in the plane parallel to the viewing surface 91 and the second particles 7 are brought in their collected state near the surface 113 of the reset electrode 13 substantially outside the light path. The optical state of the pixel 2 is red.

To obtain an optical state being ½ R ½ G, i.e. the optical state of the pixel 2 is an average of 50% red and 50% green, the red particles 6 are brought in their collected state near the surface 112 of the second electrode 12, by appropriately changing the potentials received by the electrodes 11,12,13, e.g. the electrodes 11,12,13 receive first particles positioning potentials of 0 Volts, −10 Volts and 0 Volts, respectively. Subsequently, the green particles 7 are brought in their collected state near the surface 113 of the reset electrode 13, by appropriately changing the potentials received by the electrodes 11,12,13, e.g. the electrodes 11,12,13 receive second particles reset potentials of 0 Volts, −10 Volts and 10 Volts, respectively. The reset potentials prevent the first particles 6 from substantially changing their position near the surface 112 of the second electrode 12. Subsequently, the green particles 7 are brought in their collected state near the surface 111 of the first electrode 11, by appropriately changing the potentials received by the electrodes 11,12,13, e.g. the electrodes 11,12,13 receive second particles positioning potentials of 10 Volts, −10 Volts and 0 Volts, respectively. The second particles positioning potentials prevent the first particles 6 from substantially changing their position near the surface 112 of the second electrode 12. The optical state of the pixel 2 is ½ R ½ G.

To obtain an optical state being ¼ R ¼ G ½ W (W denotes White), the red particles 6 are brought in their collected state near half of the surface 112 of the second electrode 12, by appropriately changing the potentials received by the electrodes 11,12,13, e.g. the electrodes 11,12,13 receive first particles positioning potentials of 20 Volts, −10 Volts and 0 Volts, respectively. The relatively large positive potential of the first electrode 11 compared to the potential of the second electrode 12 pushes the first particles 6 away from the portion of the surface 112 of the second electrode 12 that is near the first electrode 11. As a result only half of the surface 112 of the second electrode 12 is covered by first particles 6. Subsequently, the green particles 7 are brought in their collected state near the surface 113 of the reset electrode 13, by appropriately changing the potentials received by the electrodes 11,12,13, e.g. the electrodes 11,12,13 receive second particles reset potentials of 20 Volts, −10 Volts and 30 Volts, respectively. The reset potentials prevent the first particles 6 from substantially changing their position near the surface 112 of the second electrode 12. Subsequently, the green particles 7 are brought in their collected state near the surface 111 of the first electrode 11, by appropriately changing the potentials received by the electrodes 11,12,13, e.g. the electrodes 11,12,13 receive second particles positioning potentials of 20 Volts, −10 Volts and 0 Volts, respectively. The relatively large negative potential of the second electrode 12 compared to the potential of the first electrode 11 pushes the second particles 7 away from the portion of the surface 111 of the first electrode 11 that is near the second electrode 12. As a result only half of the surface 111 of the first electrode 11 is covered by second particles 7. The second particles positioning potentials prevent the first particles 6 from substantially changing their position near the surface 112 of the second electrode 12. As the first particles 6 cover half of the surface 112 of the second electrode 12, the uncovered half of the surface 112 of the second electrode 12 exposing white, and the second particles 7 cover half of the surface 111 of the first electrode 11, the uncovered half of the surface 111 of the first electrode 11 exposing white, the optical state of the pixel 2 is ¼ R ¼ G ½ W.

To obtain an optical state being ½ R ¼ G ¼ W the red particles 6 are brought in their collected state near the surface 112 of the second electrode 12, by appropriately changing the potentials received by the electrodes 11,12,13, e.g. the electrodes 11,12,13 receive first particles positioning potentials of 0 Volts, −10 Volts and 0 Volts, respectively. Subsequently, the green particles 7 are brought in their collected state near the surface 113 of the reset electrode 13, by appropriately changing the potentials received by the electrodes 11,12,13, e.g. the electrodes 11,12,13 receive second particles reset potentials of 0 Volts, −10 Volts and 10 Volts, respectively. The reset potentials prevent the first particles 6 from substantially changing their position near the surface 112 of the second electrode 12. Subsequently, the green particles 7 are moved towards their collected state near the surface 111 of the first electrode 11, by appropriately changing the potentials received by the electrodes 11,12,13, e.g. the electrodes 11,12,13 receive second particles positioning potentials of 10 Volts, −10 Volts and 0 Volts, respectively. If the potentials are removed from the electrodes before the green particles are completely brought into their collected state near the surface 111 of the first electrode 11, a portion of the particles will remain state near the surface 113 of the reset electrode 13 and the surface 111 of the first electrode 11 will not be fully covered by green particles 7. By correctly timing the time period whereby the potentials are applied, only half of the surface 111 of the first electrode 11 is covered by second particles 7. The second particles positioning potentials prevent the first particles 6 from substantially changing their position near the surface 112 of the second electrode 12. As the first particles 6 fully cover the surface 112 of the second electrode 12, the second particles 7 cover half of the surface 111 of the first electrode 11, the uncovered half of the surface 111 of the first electrode 11 exposing white, the optical state of the pixel 2 is ½ R ¼ G ¼ W.

It is clear that other optical states determined by other mixtures of the first and the second particles 6,7 are attainable, by tuning the values of the potentials applied to the electrodes 11,12,13.

In FIG. 3 the layout of the electrodes 11,12,13 in another embodiment of the pixel 2 is shown. In this example, the electrophoretic medium 5 is present between the first and the second electrode 11,12, and the second electrode is at the viewer side.

In FIG. 4 the layout of the electrodes 11,12,13 in another embodiment of the pixel 2 is shown. In this example, the surface 113 of the reset electrode 13 is parallel to the viewing surface and the surfaces 111,113 of the first electrode 11 and the reset electrode 13 are present in a substantially flat plane.

In FIG. 5 the layout of the electrodes 11,12,13 in another embodiment of the pixel 2 is shown. In this example, the surfaces 111,113 of the first electrode 11 and the reset electrode 13 are present in the substantially flat plane and a perpendicular projection of the surface 112 of the second electrode 12 substantially covers the surfaces 111,113 of the first electrode 11 and the reset electrode 13. The reset electrode 13 is shielded from the viewer by a light absorbing layer like a black matrix layer 513 between electrode 13 and the viewer. The region between the black matrix layer 513 and the reset electrode 13 provides a reservoir for the first and the second particles 6,7 and is substantially non-contributing to the optical state of the pixel 2. The reset electrode 13 and part of the second electrode 12 are part of the reservoir. The other part of the cell is the optical active portion. In the embodiment of FIG. 5 the positions of the particles 6,7 in the optical active portion determine the optical state of the pixel 2.

If in the embodiment of FIG. 5 also the first and the second electrode 11,12 and substrate 8 are also transparent, the display panel 1 may be used in light transmissive mode. In transmissive mode, the optical state of the pixel 2 is determined by the portion of the visible spectrum incident on the pixel 2 at the side 92 of the first substrate 8 that survives the cumulative effect of traversing through the first substrate 8, first electrode 11, medium 5, second electrode 12, and the second substrate 9.

For enabling the first and the second particles to occupy their positions for displaying the picture, the pixel 2 is being addressed as follows:
1. Reset of the positively charged first particles 6 (first particles reset potentials): the positively charged first particles 6 are collected near the surface 113 of the reset electrode 13 at a negative potential e.g. −10 Volts compared to the potentials of e.g. 0 Volts of both the first and the second electrode 11,12, subsequently
2. Fill the positively charged first particles 6 (first particles fill potentials): a relatively high negative potential is applied to the first electrode 11, e.g. −15 Volts. The potential difference between the first electrode 11 and the reset electrode 13, at e.g. −10 Volts, moves the first particles 6 from the reservoir volume into the optical active volume. The second electrode 12 is e.g. at 0 Volts. The height and duration of the potential pulse can be used for gray level control; subsequently
3. Polarity reversal (reversal potentials): equal potentials are applied to the first electrode 11 and the reset electrode 13, e.g. 10 Volts, which are larger than the potential applied to the second electrode 12, e.g. 0 Volts. Then the negatively charged second particles 7 are moved to the first and reset electrode 11,13 and the first particles 6 are moved to the second electrode 12 by means of a homogeneous electric field (in the reservoir and the optical active volume), subsequently
4. Reset the negatively charged second particles 7 (second particles reset potentials): the negatively charged second particles 7 are collected near the surface 113 of the reset electrode 13 at a positive potential e.g. 15 Volts compared to the potentials of e.g. 5 Volts of the first electrode 11 and 0 Volts of the second electrode 12. The first particles 6 are prevented from substantially changing their position, subsequently
5. Fill the negatively charged second particles 7 (second particles positioning potentials): a relatively high positive potential is applied to the first electrode 11, e.g. Volts. The potential difference between the first electrode 11 and the reset electrode 13, at e.g. 10 Volts, moves the second particles 7 from the reservoir volume into the optical active volume. The second electrode 12 is e.g. at 0 Volts, and the first particles 6 are prevented from substantially changing their position. The height and duration of the potential pulse can be used for gray level control.

FIG. 6 shows another embodiment of the display panel 1. The pixel 2 has a cell 3 having the electrophoretic medium 5, the first and the second particles 6,7 being able to occupy positions in the cell 3. Furthermore, the pixel 2 has a further cell 30 stacked on the cell 3, the further cell 30 having a further electrophoretic medium 50 having third and fourth charged particles 60,70, the third and the fourth particles 60,70 having opposite polarity and dissimilar optical properties and dissimilar optical properties with respect to the first and the second particles 6,7 and being able to occupy positions in the further cell 30. Furthermore, the pixel 2 has further electrodes 110,120,130 for receiving potentials, and an optical state depending on the position of the third and the fourth particles 60,70 in the pixel 2. Furthermore, the drive means 100 are able to control a sequence of the potentials received by the electrodes and the further electrodes 11,12,13,110,120,130 for enabling the first, the second, the third and the fourth particles 6,7,60,70 to occupy their positions for displaying the picture. A transparent middle substrate 10 is present between the cell 3 and the further cell 30. In this geometry the first, the second and the reset electrode 11,12,13 are associated with the cell 3, whereas electrodes 110,120,130 are associated with the further cell 30, and the positioning of the first and the second particles 6,7 in the cell 3 by electrodes 11,12,13 is substantially independent from the positioning of the third and fourth particles 60,70 by electrodes 110,120,130. Electrode 110 may be considered to be the first electrode of the further cell 30, electrode 120 may be considered to be the second electrode of the further cell 30, and electrode 130 may be considered to be the reset electrode of the further cell 30.

Consider the first particles 6 to be positively charged and to have a yellow color in transmission, the second particles 7 to be negatively charged and to have a cyan color in transmission, the third particles 60 to be positively charged and to have a magenta color in transmission, and the fourth particles 70 to be negatively charged and to have a black color.

The reset electrodes 13,130 are shielded from the viewer by a light absorbing layer like a black matrix layer 513 between electrodes 13,130 and the viewer. The region between the black matrix layer 513 and the reset electrode 13 in the cell 3 provides a reservoir for the first and the second particles 6,7 and is substantially non-contributing to the optical state of the pixel 2. The reset electrode 13 and part of the second electrode 12 are part of the reservoir. The other part of the cell 3 is the optical active portion. The region between the black matrix layer 513 and the reset electrode 130 in the further cell 30 provides a reservoir for the third and the fourth particles 60,70 and is substantially non-contributing to the optical state of the pixel 2. The reset electrode 130 and part of the second electrode 120 are part of the reservoir. The other part of the further cell 30 is the optical active portion.

In the embodiment of FIG. 6 the position of the particles 6,7,60,70 in the optical active portions determine the optical state of the pixel 2. Consider light to enter the pixel at the side 92 of the first substrate 8, e.g. from a (not drawn) backlight source, and to exit out of the pixel 2 via the viewing surface 91.

The pixel 2 can achieve at least the following favorable optical states: anyone of the three subtractive primary colors (yellow, cyan, magenta), anyone of the three primary colors (the optical state of the pixel is green when only the cyan and yellow particles are in the optical active portion; the optical state of the pixel is blue when only the magenta and cyan particles are in the optical active portion; the optical state of the pixel is red when only the magenta and yellow particles are in the optical active portion), black and white.

Furthermore, different intensity levels of the first and the second particles 6,7 can be obtained by tuning the values of the potentials applied to the electrodes 11,12,13, and different intensity levels of the third and the fourth particles 60,70 can be obtained by tuning the values of the potentials applied to the electrodes 110,120,130. In this way a 4 particle electrophoretic pixel 2 is envisaged with an electric sorting mechanism using 6 electrodes.

In FIG. 7 the layout of the electrodes 11,12,13 and the further electrodes 110,120,130 in another embodiment of the pixel 2 are shown. In this example, the electrode structure in the further cell 30 is a mirror image along the middle substrate 10 of the electrode structure in the cell 3.

In FIG. 8 the layout of the electrodes 11,12,13 and the further electrodes 110,130 in another embodiment of the pixel 2 are shown. In this example, electrode 12 also “functions as the second electrode” for the further cell 30. In this way a 4 particle electrophoretic pixel 2 is envisaged with an electric sorting mechanism using only 5 electrodes.

In FIG. 9 the layout of the electrodes 11,12,13 and the further electrodes 140,150,160,170 in another embodiment of the pixel 2 are shown. In this example, the further cell 30 has one reservoir having electrodes 140,150 for the third particles 60 and another reservoir having electrodes 160,170 for the fourth particles 70.

1. An electrophoretic display panel (1) for displaying a picture comprising
a pixel (2) having
an electrophoretic medium (5) comprising first and second charged particles (6,7), the first and the second particles (6,7) having opposite polarity and dissimilar optical properties and being able to occupy positions in the pixel (2),
a first, a second and a reset electrode (11,12,13) for receiving potentials,
an optical state depending on the positions of the particles (6,7) in the pixel (2), and
drive means (100) for controlling a sequence of the potentials received by the electrodes (11,12,13) for enabling the first and the second particles (6,7) to occupy their positions for displaying the picture, the sequence comprising
first particles positioning potentials for enabling the first particles (6) to occupy a position for displaying the picture, subsequently
second particles reset potentials for enabling the second particles (7) to occupy a position near the reset electrode (13) and for preventing the first particles (6) from substantially changing their contribution to the optical state of the pixel (2), subsequently
second particles positioning potentials for enabling the second particles (7) to occupy a position for displaying the picture and for preventing the first particles (6) from substantially changing their contribution to the optical state of the pixel (2).

2. A display panel (1) as claimed in claim 1 characterized in that the first particles positioning potentials comprise first particles fill potentials for enabling the first particles (6) to occupy a position near the first electrode (11) based on the position for displaying the picture, and subsequently reversal potentials for enabling the first particles (6) to occupy a position near the second electrode (12) for displaying the picture.

3. A display panel (1) as claimed in claim 1 characterized in that the reversal potentials further enable the second particles (7) to occupy a position near the first electrode (11).

4. A display panel (1) as claimed in claim 1 characterized in that the sequence comprises first particles reset potentials for enabling the first particles (6) to occupy a position near the reset electrode (13) prior to the first particles positioning potentials.

5. A display panel (1) as claimed in claim 4 characterized in that the pixel (2) has a viewing surface (91) for being viewed by a viewer, and the first, the second and the reset electrodes (11,12,13) have substantially flat surfaces (111,112,113) facing the particles (6,7), and the surfaces of the first and the second electrodes (11,12) are substantially parallel to the viewing surface (91).

6. A display panel (1) as claimed in claim 5 characterized in that the electrophoretic medium (5) is present between the first and the second electrode (11,12), one of the first and the second electrode being at the viewer side and the other of the first and the second electrode being at the opposite side.

7. A display panel (1) as claimed in claim 6 characterized in that the surface (113) of the reset electrode (13) is substantially parallel to the viewing surface (91) and the surfaces of the reset electrode (13) and one of the first and the second electrodes are present in a substantially flat plane.

8. A display panel (1) as claimed in claim 7 characterized in that the surfaces (113,111) of the reset electrode (13) and the first electrode (11) are present in the substantially flat plane and a perpendicular projection of the surface (112) of the second electrode (12) substantially covers the surfaces (111,113) of the first electrode (11) and the reset electrode (13).

9. A display panel (1) as claimed in claim 1 characterized in that the pixel (2) comprises a reservoir portion substantially non-contributing to the optical state of the pixel (2) and an optical active portion substantially contributing to the optical state of pixel (2).

10. A display panel (1) as claimed in claim 9 characterized in that the reservoir portion comprises the reset electrode (13).

11. A display panel (1) as claimed in claim 10 characterized in that the reservoir portion comprises a part of the second electrode (12).

12. A display panel (1) as claimed in claim 1 characterized in comprising a plurality of pixels (2) and electronic switching elements, a single one for each pixel (2) being connected to the first electrode (11) of the associated one of the pixels (2).

13. A display panel (1) as claimed in claim 1 characterized in that
the pixel (2) has
a cell (3) comprising the electrophoretic medium (5), the first and the second particles (6,7) being able to occupy positions in the cell (3),
a further cell (30) stacked on the cell (3), the further cell (30) comprising a further electrophoretic medium (50) comprising third charged particles (60), the third particles (60) having dissimilar optical properties with respect to the first and the second particles (6,7) and being able to occupy positions in the further cell (30),
further electrodes (110,120,130) for receiving potentials,
an optical state depending on the position of the third particles (60) in the pixel (2), and
the drive means (100) are able to control a sequence of the potentials received by the electrodes (11,12,13) and the further electrodes (110,120,130) for enabling the first, the second and the third particles (6,7,60) to occupy their positions for displaying the picture.

14. A display panel (1) as claimed in claim 13 characterized in that the drive means (100) are able to control the sequence of the potentials received by the further electrodes (110,120,130) for enabling the third particles (60) to occupy their positions for displaying the picture.

15. A display panel (1) as claimed in claim 1 characterized in that
the pixel (2) has
a cell (3) comprising the electrophoretic medium (5), the first and the second particles (6,7) being able to occupy positions in the cell (3),
a further cell (30) stacked on the cell (3), the further cell (30) comprising a further electrophoretic medium (50) comprising third and fourth charged particles (60,70), the third and the fourth particles (60,70) having opposite polarity and dissimilar optical properties and dissimilar optical properties with respect to the first and the second particles (6,7) and being able to occupy positions in the further cell (30),
further electrodes (110,120,130) for receiving potentials,
an optical state depending on the position of the third and the fourth particles (60,70) in the pixel (2), and
the drive means (100) are able to control a sequence of the potentials received by the electrodes (11,12,13) and the further electrodes (110,120,130) for enabling the first, the second, the third and the fourth particles (6,7,60,70) to occupy their positions for displaying the picture.

16. A display panel (1) as claimed in claim 15 characterized in that the drive means (100) are able to control the sequence of the potentials received by the further electrodes (110,120,130) for enabling the third and the fourth particles (60,70) to occupy their positions for displaying the picture.

17. A display device comprising an electrophoretic display panel (1) according to claim 1 and circuitry to provide image information to said display panel (1).

18. Method of driving an electrophoretic display panel (1), said electrophoretic display panel (1) for displaying a picture comprising a pixel (2) having
an electrophoretic medium (5) comprising first and second charged particles (6,7), the first and the second particles (6,7) having opposite polarity and dissimilar optical properties and being able to occupy positions in the pixel (2),
a first, a second and a reset electrode (11,12,13) for receiving potentials, and
an optical state depending on the positions of the particles (6,7) in the pixel (2),
said method comprising the step of controlling a sequence of the potentials received by the electrodes (11,12,13) for enabling the first and the second particles (6,7) to occupy their positions for displaying the picture, the sequence comprising
first particles positioning potentials for enabling the first particles (6) to occupy a position for displaying the picture, subsequently
second particles reset potentials for enabling the second particles (7) to occupy a position near the reset electrode (13) and for preventing the first particles (6) from substantially changing their contribution to the optical state of the pixel (2), subsequently
second particles positioning potentials for enabling the second particles (7) to occupy a position for displaying the picture and for preventing the first particles (6) from substantially changing their contribution to the optical state of the pixel (2).

19. Drive means (100) for driving an electrophoretic display panel (1), said electrophoretic display panel (1) for displaying a picture comprising a pixel (2) having
an electrophoretic medium (5) comprising first and second charged particles (6,7), the first and the second particles (6,7) having opposite polarity and dissimilar optical properties and being able to occupy positions in the pixel (2),
a first, a second and a reset electrode (11,12,13) for receiving potentials, and
an optical state depending on the positions of the particles (6,7) in the pixel (2),
said drive means (100) being arranged for controlling a sequence of the potentials received by the electrodes (11,12,13) for enabling the first and the second particles (6,7) to occupy their positions for displaying the picture, the sequence comprising
first particles positioning potentials for enabling the first particles (6) to occupy a position for displaying the picture, subsequently
second particles reset potentials for enabling the second particles (7) to occupy a position near the reset electrode (13) and for preventing the first particles (6) from substantially changing their contribution to the optical state of the pixel (2), subsequently
second particles positioning potentials for enabling the second particles (7) to occupy a position for displaying the picture and for preventing the first particles (6) from substantially changing their contribution to the optical state of the pixel (2).
